(19) United States
(12) Patent Application Publication
(10) Pub. No.: US 2017/0223952 A1
(43) Pub. Date: Aug. 10, 2017

(54) Use Of Etherified Lactate Esters For Reducing The Drift During The Application Of Plant-Treatment Agents

(71) Applicant: Clariant International Ltd., Muttenz (CH)

(72) Inventors: Peter BAUR, Schondorf (DE); Martin BAUER, Frankfurt am Main (DE); Siegfried STAIGER, Frankfurt am Main (DE)

(73) Assignee: Clariant International Ltd., Muttenz (CH)

(21) Appl. No.: 15/502,998

(22) PCT Filed: Aug. 13, 2015
(86) PCT No.: PCT/EP2015/068715

§ 371 Date: Feb. 9, 2017

(30) Foreign Application Priority Data
Aug. 15, 2014 (DE) 10 2014 011 961.0
Aug. 18, 2014 (DE) 10 2014 012 054.6

(51) Int. Cl. A01N 25/24; A01N 25/02

(52) U.S. Cl. CPC A01N 25/24; A01N 25/02

(57) ABSTRACT

The invention relates to the use of one or more etherified lactate esters of formula (I) for reducing the drift during the application of plant-treatment agents, wherein R represents an unbranched or branched saturated alkyl, having 1 to 30 carbon atoms, or an unbranched or branched mono- or polyunsaturated alkenyl having 2 to 30 carbon atoms, R1 represents a radical of formula -(AO)ₘ-R′, (AO)ₘ, which is composed of ethylene oxide units, composed of propylene oxide units, composed of butylene oxide units, composed of mixtures of ethylene oxide- and propylene oxide units, or composed of mixtures of ethylene oxide units and butylene oxide units, wherein m represents on average an integer between 1 and 30, and R′ represents hydrogen, a branched or unbranched saturated alkyl radical having 1 to 20 carbon atoms, or a branched or unbranched mono- or polyunsaturated alkylene radical having 2 to 20 carbon atoms.

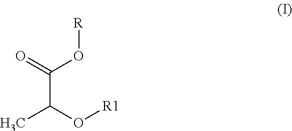

The invention relates to the use of particular etherified lactate esters as drift-reducing components in crop treatment compositions and to the use of particular etherified lactate esters for reducing drift on application of crop treatment compositions, to a method of reducing drift on application of crop treatment compositions, and to compositions for reducing drift.

Crop protection compositions are applied to agricultural production fields in a very efficient manner using spray tanks in aircraft, tractors or other equipment. In order to achieve very exact positioning of the active substances, it is necessary to obtain a very narrow spray cone and to prevent drift of the spray mist away from the target site.

The drift of the spray mist is determined essentially by the droplet size distribution. The smaller the droplets, the longer the residence time in the air and the greater their tendency to drift horizontally and to evaporate and/or to miss the target site. The literature discloses that the fine droplet fraction of <150 μm (Teske et al., 2004, The Role of Small Droplets in Classifying Drop Size Distributions, ILASS Americas 17th Annual Conference, Arlington Va.), especially <100 μm (Vermeer et al., Proc. ISAA 2013, The use of adjuvanted formulations for drift control) determines the proportion of droplets in the spray mist that contributes to the drift effect. The reduction of the fine droplet content in the spray mist is therefore crucial to reduction of drift and is therefore utilized for determination of the drift properties of a composition.

Distinct minimization of the drift effect can be achieved by addition of suitable “drift control agents” to crop protection formulations, and these bring about a decrease in the fine droplet content and hence an increase in droplet size in the spray mist. The formulations modified with “drift control agents” additionally have to be insensitive to the shear forces to which they are exposed in the spray pumps and nozzles. Good biodegradability, compatibility with other constituents of the crop protection compositions and high storage stability and thermal stability are further requirements for “drift control agents”. It is known that the rheology of aqueous compositions can be modified by addition of water-soluble polymers, for example polyacrylamides, acrylamide/acrylic acid polymers, sodium polyacrylate, carboxymethyl cellulose, hydroxyethyl cellulose, methyl cellulose, polysaccharides, natural and synthetic guar gum (U.S. Pat. No. 4,413,087, U.S. Pat. No. 4,505,827, U.S. Pat. No. 5,874,096), these leading to a shift in the droplet size spectrum toward larger droplets.

Molasses and organic thickeners have also been described as effective drift reduction agents (Pesticide Drift III; Drift Reduction with Spray Thickeners; Ware, G. W. et al.; J. of Economic Entomology 63; 1314-1316; 1970). It is additionally known that particular emulsions—via a mechanism which is not fully understood—lead to a reduced fine droplet content (Vermeer et al.; Crop Protection 44; 2013; Spray drift review: The extent to which a formulation can contribute to spray drift reduction).

Even though good results are already achieved with the known systems, there is still a need, for technical, economic and ecological reasons, to find suitable “drift control agents” which, even under practical conditions, effectively increase the droplet volumes of the aqueous compositions and reduce drift of the spray mist. Especially the conflict with crop protection composition formulations, fertilizers and interface-active tankmix additives limits the effect of the “drift control agents”, and more robust products are needed.

It has now been found that, surprisingly, particular etherified lactate esters are suitable as drift-reducing adjuvants for crop treatment compositions and, on spraying of these crop treatment compositions, bring about an effective increase in the size of the droplets through a reduction in the fine droplet content in the spray mist. It has thus been found that, surprisingly, these particular etherified lactate esters are suitable for use for reduction of drift on application of crop treatment compositions.

The invention therefore provides for the use of one or more etherified lactate esters of the formula (I)

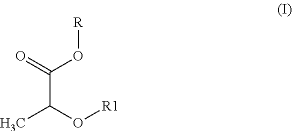

in which
R is unbranched or branched saturated alkyl having 1 to 30 carbon atoms or is unbranched or branched, mono- or polyunsaturated alkenyl having 2 to 30 carbon atoms,
R1 is a radical of the formula -(AO)ₘ-R′,
(AO)ₘ is formed from ethylene oxide units, is formed from propylene oxide units, is formed from butylene oxide units, is formed from mixtures of ethylene oxide and propylene oxide units or is formed from mixtures of ethylene oxide and butylene oxide units, where m on average is a number from 1 to 30, and
R′ is hydrogen, a branched or unbranched saturated alkyl radical having 1 to 20 carbon atoms or is a branched or unbranched, mono- or polyunsaturated alkenyl radical having 2 to 20 carbon atoms,
   for reducing drift on application of crop treatment compositions.

In the context of the present invention, the ethylene oxide units (—C₂H₄O—), propylene oxide units (—C₃H₆O—) and butylene oxide units (—C₄H₈O—) are also referred to hereinafter simply as EO, PO and BO units respectively.

In the compounds of the formula (I), the variable “m” is a numerical average.

“Crop treatment compositions” in the context of the invention are preferably understood to mean compositions containing one or more substances selected from the group consisting of pesticides, phytohormones, preferably growth regulators, biological control agents, salts that can be deployed in water, preferably fertilizers or plant nutrients, or fungicidal copper compounds, and repellents. The one or more substances just mentioned, selected from the group consisting of pesticides, phytohormones, preferably growth regulators, biological control agents, salts that can be deployed in water, preferably fertilizers or plant nutrients, or fungicidal copper compounds, and repellents, are referred to in the context of the present invention as “agrochemical substances”.

“Drift” in the context of the invention is understood to mean the effect that the spraying of the crop treatment composition forms small droplets which can be borne beyond the area to be treated, and can thus make the spraying less effective or even harmful to adjacent areas and crops.

In addition to the drift, relatively small droplets have a tendency to increased vaporization, which can lead to reduced availability of the active ingredient in the target area.

In the context of the present invention, what is meant by “drift reduction” or “reducing drift” is preferably the reduction of the proportion of fine droplets having a diameter of <105 μm in the spray mist compared to the application of a composition which does not contain the etherified lactate esters of the formula (I), preferably by at least 10% and more preferably by at least 25%.

It is known that the presence of particular substances in aqueous spray liquors increases the fine droplet content in the spray mist compared to aqueous spray liquors which do not contain these substances. If etherified lactate esters of the formula (I) are added to these spray liquors having an elevated fine droplet content, the relative reduction in drift may be even much higher than that specified above.

“Application” of a crop treatment composition in the form of a spray liquor containing one or more agrochemical substances in the context of the invention is understood to mean the application of an aqueous spray liquor containing one or more agrochemical substances to the plants to be treated or the site thereof.

Etherified lactate esters are already known in general terms from WO 2013/14126 A1 as additives to crop protection compositions. However, no hint of possible suitability for reducing drift can be inferred from the document.

The one or more etherified lactate esters used in accordance with the invention are defined in general terms by the formula (I). Preferred radical definitions of the above formula (I) which are specified hereinafter for the use of the invention, but also for the method of the invention and for the compositions of the invention, are specified hereinafter.

Preference is given to the following compounds of the formula (I):
R is unbranched or branched saturated alkyl having 2 to 18 carbon atoms or is unbranched or branched, mono- or polyunsaturated alkenyl having 2 to 18 carbon atoms,
R1 is a radical of the formula -(AO)ₘ-R′,
(AO)ₘ is formed from ethylene oxide units, is formed from propylene oxide units, is formed from butylene oxide units, is formed from mixtures of ethylene oxide and propylene oxide units or is formed from mixtures of ethylene oxide and butylene oxide units, where m on average is a number from 1 to 20, preferably 2 to 20, and

R′ is hydrogen, a branched or unbranched saturated alkyl radical having 1 to 18 carbon atoms or is a branched or unbranched, mono- or polyunsaturated alkenyl radical having 2 to 18 carbon atoms.

Particular preference is given to the following compounds of the formula (I):
R is butyl, preferably n-butyl, hexyl, ethylhexyl, preferably 1-ethylhexyl, 2-ethylhexyl, 3-ethylhexyl or 4-ethylhexyl, capryl (C8), caprinyl (C10), lauryl (C12), myristyl (C14), cetyl (C16), stearyl (C18) or oleyl (C18, unsaturated),
R1 is a radical of the formula -(AO)ₘ-R′,
(AO)ₘ is formed from ethylene oxide units, is formed from propylene oxide units, is formed from butylene oxide units or is formed from mixtures of ethylene oxide and propylene oxide units, where m on average is a number from 1 to 20, preferably 2 to 20 and more preferably 2 to 15, and
R′ is hydrogen, a branched or unbranched saturated alkyl radical having 1 to 10 carbon atoms or is a branched or unbranched, mono- or polyunsaturated alkenyl radical having 2 to 10 carbon atoms and is preferably hydrogen or methyl.

Especially preferred are the following compounds of the formula (I):
R is ethylhexyl, preferably 2-ethylhexyl,
R1 is -(AO)ₘ-R′,
(AO)ₘ is selected from the group consisting of the following radicals:
   a) (PO)ₓ(EO)_{y} in which x on average is a number from 1 to 5 and y on average is a number from 1 to 10, and preferably x on average is a number from 1 to 2 and y on average is a number from 1 to 5, and
   b) (EO)_{y} in which y on average is a number from 1 to 10 and preferably on average is a number from 1 to 5, and
R′ is hydrogen.

Further especially preferred are the following compounds of the formula (I):
R is lauryl,
R1 is -(AO)ₘ-R′,
(AO)ₘ is selected from the group consisting of the following radicals:
   a) (PO)ₓ(EO)_{y} in which x on average is a number from 1 to 5 and y on average is a number from 1 to 10, and preferably x on average is a number from 1 to 2 and y on average is a number from 1 to 5, and
   b) (EO)_{y} in which y on average is a number from 1 to 10 and preferably on average is a number from 1 to 5, and
R′ is hydrogen.

Further especially preferred are the following compounds of the formula (I):
R is cetyl,
R1 is -(AO)ₘ-R′,
(AO)ₘ is selected from the group consisting of the following radicals:
   a) (PO)ₓ(EO)_{y} in which x on average is a number from 1 to 5 and y on average is a number from 1 to 10, and preferably x on average is a number from 1 to 2 and y on average is a number from 1 to 5, and
   b) (EO)_{y} in which y on average is a number from 1 to 10 and preferably on average is a number from 1 to 5, and
R′ is hydrogen.

Further especially preferred are the following compounds of the formula (I):
R is butyl,
R1 is -(AO)ₘ-R′,
(AO)ₘ is (PO)ₓ(EO)_{y} in which x on average is a number from 1 to 10 and y on average is a number from 1 to 10, and preferably x on average is a number from 1 to 5 and y on average is a number from 1 to 5, and
R′ is hydrogen.

In the compounds of the formula (I), the variables “x” and “y” are numerical averages.

The etherified lactate esters used in accordance with the invention that are described here include all enantiomers. Preferably, the etherified lactate esters used in accordance with the invention are in the (S) form, but the (R) form and mixtures of the (S) and (R) form likewise have good usability.

The etherified lactate esters can be prepared by the process described in WO 2013/014126 A1. For this purpose, the lactate esters of the formula (II) in which R is as defined above and in which R2 is R′, where R′ is as defined above,

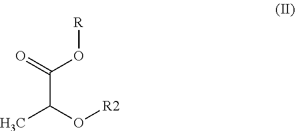

are prepared with alkylene oxides (ethylene oxide EO, propylene oxide PO, butylene oxide BO or mixtures thereof) in the presence of DMC catalysts (double metal cyanide complex catalysts). The process conditions, the process procedure and the catalyst are known in principle from EP-B-1 702 941. In this regard, reference is made to EP-B-1 702 941, especially ([0015])-([0029]).

The lactate esters of the formula (II) used as precursor are commercially available. The process can be conducted as follows:

DMC catalysts suitable for the process are known in principle from the prior art (see, for example, U.S. Pat. No. 3,404,109, U.S. Pat. No. 3,829,505, U.S. Pat. No. 3,941,849 and U.S. Pat. No. 5,158,922). DMC catalysts described, for example, in U.S. Pat. No. 5,470,813, EP-A-700949, EP-A-743093, EP-A-761708, WO 97/40086, WO 98/16310, WO 00/47649 and WO 01/80994 have very high activity in the polymerization of alkylene oxides and enable the preparation of polyethers under optimal conditions with very low catalyst concentrations (100 ppm or less), such that there is generally no need to remove the catalyst from the finished product. A typical example is that of the high-activity DMC catalysts described in EP-A-700949, which, as well as a double metal cyanide compound (e.g. zinc hexacyanocobaltate(III)) and an organic complex ligand (e.g. tert-butanol), also contain a polyether having a number-average molecular weight greater than 500 g/mol.

The lactate esters of the formula (II) used as starter components can be initially charged in the reactor or supplied continuously to the reactor together with the alkylene oxides during the reaction. In the case of the latter procedure, the reactor is typically initially charged with a small amount of an addition product formed from lactate ester of the formula (II) and alkylene oxide; this may also be the product to be prepared. It is likewise possible to withdraw reaction product continuously from the reactor; in this case, as well as alkylene oxide and the starter component, the DMC catalyst also has to be metered in continuously. The process variants for preparation of alkylene oxide addition products under DMC catalysis with continuous metered addition of the starter components are described, for example, in WO 97/29146 and WO 98/03571.

The DMC-catalyzed reaction of the lactate esters of the formula (II) with the alkylene oxides is effected generally at temperatures of 20 to 200° C., preferably of 40 to 180° C., more preferably at temperatures of 50 to 150° C. The reaction can be conducted at total pressures of 0.0001 to 20 bar (absolute). The polyaddition can be conducted in substance or an inert organic solvent such as toluene and/or tetrahydrofuran (THF). The amount of solvent is typically 10% to 30% by weight, based on the amount of the etherified lactate ester to be prepared.

The catalyst concentration is chosen such that good control of the polyaddition reaction is possible under the given reaction conditions. The catalyst concentration is generally 0.0005% by weight to 1% by weight, preferably 0.001% by weight to 0.1% by weight, more preferably 0.001% by weight to 0.03% by weight, based on the amount of the etherified lactate ester to be prepared. It is possible to add small amounts (1-500 ppm, based on the amount of starter) of organic or inorganic acids to the lactate esters of the formula (II) used as starter components, as described in WO 99/14258.

It is optionally possible to add aging stabilizers, for example antioxidants, to the etherified lactate esters prepared in this way.

The compounds of the formula (I) are used in accordance with the invention individually or in the form of mixtures. If the description or the claims refer to one or more etherified lactate esters, this explicitly means individual compounds or mixtures of two or more compounds. The etherified lactate esters of the formula (I) used in accordance with the invention, as the case may be, may take the form of mixtures of different possible isomeric forms, especially of stereoisomers, for example E and Z isomers, threo and erythro isomers, and optical isomers. Preference is given to using L-lactate derivatives of the formula (I).

The compounds of the formula (I) can be used in all standard formulation types, preferably in liquid formulations. In principle, the compounds can also be introduced into solid formulations.

A preferred embodiment of the invention is the use of the one or more etherified lactate esters of the formula (I) for reducing drift on application of crop treatment compositions as a tankmix additive, meaning that the etherified lactate esters of the formula (I) are not added until directly prior to deployment of a spray liquor produced from a concentrated formulation.

Another preferred embodiment of the invention is the use of the one or more etherified lactate esters of the formula (I) for reducing drift on application of crop treatment compositions as an in-can variant, meaning that the etherified lactate esters of the formula (I) are already incorporated into a concentrated formulation together with the ingredients of the crop treatment composition and are deployed as spray liquor diluted with water.

The inventive use of the one or more etherified lactate esters of the formula (I) is preferably effected in ready-to-use crop treatment compositions in the form of spray liquors, in which case the amount of the one or more etherified lactate esters of the formula (I) in the spray liquor is preferably from 0.001% to 5% by weight, more preferably from 0.005% to 3% by weight, especially preferably from 0.01% to 1% by weight and exceptionally preferably from 0.03% to 0.5% by weight, based in each case on the total weight of the spray liquor.

If a crop treatment composition contains two or more etherified lactate esters, the stated amount should be understood as the total content of all the etherified lactate esters.

The radical definitions, value ranges and elucidations given above, in general terms or in areas of preference, can be combined with one another as desired, i.e. including combinations between the particular ranges and ranges of preference.

The mechanism of action of the etherified lactate esters for reducing drift on application of crop treatment compositions is basically independent of the nature of the agrochemical substance used. However, the selection of the optimal alkoxylation level of the etherified lactate esters of the formula (I) for maximum drift reduction on application can be influenced by any cloud point-lowering substances present in the crop treatment compositions, for example active ingredient salts or other salts.

The one or more etherified lactate esters of the formula (I) can be used in the production of crop treatment compositions. The result here is compositions used in accordance with the invention that contain one or more etherified lactate esters of the formula (I) and one or more agrochemical substances.

“Pesticides” are understood in the context of the present invention to mean herbicides, fungicides, insecticides, acaricides, bactericides, molluscicides, nematicides and rodenticides. An overview of the most relevant pesticides can be found, for example, in “The Pesticide Manual” from the British Crop Protection Council, 16^{th} Edition 2012, editor: C. MacBean. Explicit reference is hereby made to the active ingredients listed therein. They are incorporated into this description by citation.

Examples of fungicides include:

(1) Ergosterol biosynthesis inhibitors, for example aldimorph, azaconazole, bitertanol, bromuconazole, cyproconazole, diclobutrazole, difenoconazole, diniconazole, diniconazole-M, dodemorph, dodemorph acetate, epoxiconazole, etaconazole, fenarimol, fenbuconazole, fenhexamid, fenpropidin, fenpropimorph, fluquinconazole, flurprimidol, flusilazole, flutriafol, furconazole, furconazole-cis, hexaconazole, imazalil, imazalil sulfate, imibenconazole, ipconazole, metconazole, myclobutanil, naftifin, nuarimol, oxpoconazole, paclobutrazole, pefurazoate, penconazole, piperalin, prochloraz, propiconazole, prothioconazole, pyributicarb, pyrifenox, quinconazole, simeconazole, spiroxamine, tebuconazole, terbinafine, tetraconazole, triadimefon, triadimenol, tridemorph, triflumizole, triforine, triticonazole, uniconazole, uniconazole-p, viniconazole, voriconazole, 1-(4-chlorophenyl)-2-(1H-1,2,4-triazol-1-yl)cycloheptanol, methyl 1-(2,2-dimethyl-2,3-dihydro-1H-inden-1-yl)-1H-imidazole-5-carboxylate, N′-{5-(difluoromethyl)-2-methyl-4-[3-(trimethylsilyl)propoxy]phenyl}-N-ethyl-N-methylimidoformamide, N-ethyl-N-methyl-N′-{2-methyl-5-(trifluoromethyl)-4-[3-(trimethylsilyl)propoxy]phenyl}-imidoformamide and O-[1-(4-methoxyphenoxy)-3,3-dimethylbutan-2-yl] 1H-imidazole-1-carbothioate.

(2) Respiration inhibitors (respiratory chain inhibitors), for example bixafen, boscalid, carboxin, diflumetorim, fenfuram, fluopyram, flutolanil, fluxapyroxad, furametpyr, furmecyclox, isopyrazam mixture of the syn-epimeric racemate 1RS,4SR,9RS and of the anti-epimeric racemate 1RS,4SR,9SR, isopyrazam (anti-epimeric racemate), isopyrazam (anti-epimeric enantiomer 1R,4S,9S), isopyrazam (anti-epimeric enantiomer 1S,4R,9R), isopyrazam (syn-epimeric racemate 1RS,4SR,9RS), isopyrazam (syn-epimeric enantiomer 1R,4S,9R), isopyrazam (syn-epimeric enantiomer 1S,4R,9S), mepronil, oxycarboxin, penflufen, penthiopyrad, sedaxane, thifluzamid, 1-methyl-N-[2-(1,1,2,2-tetrafluoroethoxy)phenyl]-3-(trifluoromethyl)-1H-pyrazole-4-carboxamide, 3-(difluoromethyl)-1-methyl-N-[2-(1,1,2,2-tetrafluoroethoxy)phenyl]-1H-pyrazole-4-carboxamide, 3-(difluoromethyl)-N-[4-fluoro-2-(1,1,2,3,3,3-hexafluoropropoxy)phenyl]-1-methyl-1H-pyrazole-4-carboxamide, N-[1-(2,4-dichlorophenyl)-1-methoxypropan-2-yl]-3-(difluoromethyl)-1-methyl-1H-pyrazole-4-carboxamide, 5,8-difluoro-N-[2-(2-fluoro-4-{[4-(trifluoromethyl)pyridin-2-yl]oxy}phenyl)ethyl]-quinazoline-4-amine, N-[9-(dichloromethylene)-1,2,3,4-tetrahydro-1,4-methanonaphthalen-5-yl]-3-(difluoromethyl)-1-methyl-1H-pyrazole-4-carboxamide, N-[(1S,4R)-9-(dichloromethylene)-1,2,3,4-tetrahydro-1,4-methanonaphthalen-5-yl]-3-(difluoromethyl)-1-methyl-1H-pyrazole-4-carboxamide and N-[(1R,4S)-9-(dichloromethylene)-1,2,3,4-tetrahydro-1,4-methanonaphthalen-5-yl]-3-(difluoromethyl)-1-methyl-1H-pyrazole-4-carboxamide.

(3) Respiration inhibitors (respiratory chain inhibitors) acting on complex III of the respiratory chain, for example ametoctradin, amisulbrom, azoxystrobin, cyazofamid, coumethoxystrobin, coumoxystrobin, dimoxystrobin, enestroburin, famoxadone, fenamidone, fenoxystrobin, fluoxastrobin, kresoxim-methyl, metominostrobin, orysastrobin, picoxystrobin, pyraclostrobin, pyrametostrobin, pyraoxystrobin, pyribencarb, triclopyricarb, trifloxystrobin, (2E)-2-(2-{[6-(3-chloro-2-methylphenoxy)-5-fluoropyrimidin-4-yl]oxy}phenyl)-2-(methoxyimino)-N-methylethanamide, (2E)-2-(methoxyimino)-N-methyl-2-(2-{[({(1E)-1-[3-(trifluoromethyl)phenyl]ethylidene}amino)oxy]methyl}-phenyl)ethanamide, (2E)-2-(methoxyimino)-N-methyl-2-{2-[(E)-({1-[3-(trifluoromethyl)phenyl]ethoxy}imino)-methyl]phenyl}ethanamide, (2E)-2-{2-[({[(1E)-1-(3-{[(E)-1-fluoro-2-phenylethenyl]oxy}phenyl)ethylidene]-amino}oxy)methyl]phenyl}-2-(methoxyimino)-N-methylethanamide, (2E)-2-{2-[({[(2E,3E)-4-(2,6-dichlorophenyl)but-3-en-2-ylidene]amino}oxy)methyl]-phenyl}-2-(methoxyimino)-N-methylethanamide, 2-chloro-N-(1,1,3-trimethyl-2,3-dihydro-1H-inden-4-yl)pyridine-3-carboxamide, 5-methoxy-2-methyl-4-(2-{[({(1E)-1-[3-(trifluoromethyl)phenyl]ethylidene}amino)oxy]methyl}-phenyl)-2,4-dihydro-3H-1,2,4-triazol-3-one, methyl (2E)-2-{2-[({cyclopropyl[(4-methoxyphenyl)imino]-methyl}sulfanyl)methyl]phenyl}-3-methoxyprop-2-enoate, N-(3-ethyl-3,5,5-trimethylcyclohexyl)-3-(formylamino)-2-hydroxybenzamide, 2-{2-[(2,5-dimethylphenoxy)methyl]-phenyl}-2-methoxy-N-methylacetamide and (2R)-2-{2-[(2,5-dimethylphenoxy)methyl]phenyl}-2-methoxy-N-methylacetamide.

(4) Mitosis and cell division inhibitors, for example benomyl, carbendazim, chlorfenazole, diethofencarb, ethaboxam, fluopicolide, fuberidazole, pencycuron, thiabendazole, thiophanate-methyl, thiophanate, zoxamide, 5-chloro-7-(4-methylpiperidin-1-yl)-6-(2,4,6-trifluorophenyl)[1,2,4]triazolo[1,5-a]pyrimidine and 3-chloro-5-(6-chloropyridin-3-yl)-6-methyl-4-(2,4,6-trifluorophenyl)pyridazine.

(5) Compounds with multisite activity, for example Bordeaux mixture, captafol, captan, chlorothalonil, copper preparations such as copper hydroxide, copper naphthenate, copper oxide, copper oxychloride, copper sulfate, dichlofluanid, dithianon, dodine, dodine free base, ferbam, fluorofolpet, folpet, guazatine, guazatine acetate, iminoctadine, iminoctadine albesilate, iminoctadine triacetate, mancopper, mancozeb, maneb, metiram, metiram zinc, oxine-copper, propamidine, propineb, sulfur and sulfur preparations, for example calcium polysulfide, thiram, tolylfluanid, zineb and ziram.

(6) Resistance inductors, for example acibenzolar-S-methyl, isotianil, probenazole and tiadinil.

(7) Amino acid and protein biosynthesis inhibitors, for example andoprim, blasticidin-S, cyprodinil, kasugamycin, kasugamycin hydrochloride hydrate, mepanipyrim, pyrimethanil and 3-(5-fluoro-3,3,4,4-tetramethyl-3,4-dihydroisoquinolin-1-yl)quinoline.

(8) Inhibitors of ATP production, for example, fentin acetate, fentin chloride, fentin hydroxide and silthiofam.

(9) Cell wall synthesis inhibitors, for example benthiavalicarb, dimethomorph, flumorph, iprovalicarb, mandipropamid, polyoxins, polyoxorim, validamycin A and valifenalate.

(10) Lipid and membrane synthesis inhibitors, for example biphenyl, chloroneb, dicloran, edifenphos, etridiazole, iodocarb, iprobenfos, isoprothiolane, propamocarb, propamocarb hydrochloride, prothiocarb, pyrazophos, quintozene, tecnazene and tolclofos-methyl.

(11) Melanin biosynthesis inhibitors, for example carpropamid, diclocymet, fenoxanil, fthalide, pyroquilon, tricyclazole and 2,2,2-trifluoroethyl {3-methyl-1-[(4-methylbenzoyl)amino]butan-2-yl}carbamate.

(12) Nucleic acid synthesis inhibitors, for example benalaxyl, benalaxyl-M (kiralaxyl), bupirimate, clozylacon, dimethirimol, ethirimol, furalaxyl, hymexazol, metalaxyl, metalaxyl-M (mefenoxam), ofurace, oxadixyl and oxolinic acid.

(13) Signal transduction inhibitors, for example chlozolinate, fenpiclonil, fludioxonil, iprodione, procymidone, quinoxyfen and vinclozolin.

(14) Decouplers, for example binapacryl, dinocap, ferimzone, fluazinam and meptyldinocap.

(15) Further compounds, for example benthiazole, bethoxazin, capsimycin, carvone, chinomethionat, pyriofenone (chlazafenone), cufraneb, cyflufenamid, cymoxanil, cyprosulfamide, dazomet, debacarb, dichlorophen, diclomezine, difenzoquat, difenzoquat methylsulfate, diphenylamine, ecomat, fenpyrazamine, flumetover, fluoromide, flusulfamide, flutianil, fosetyl-aluminum, fosetyl-calcium, fosetyl-sodium, hexachlorobenzene, irumamycin, methasulfocarb, methyl isothiocyanate, metrafenon, mildiomycin, natamycin, nickel dimethyldithiocarbamate, nitrothal-isopropyl, octhilinone, oxamocarb, oxyfenthiin, pentachlorophenol and salts thereof, phenothrin, phosphoric acid and salts thereof, propamocarb-fosetylate, propanosine-sodium, proquinazid, pyrimorph, (2E)-3-(4-tert-butylphenyl)-3-(2-chloropyridin-4-yl)-1-(morpholin-4-yl)prop-2-en-1-one, (2Z)-3-(4-tert-butylphenyl)-3-(2-chloropyridin-4-yl)-1-(morpholin-4-yl)prop-2-en-1-one, pyrrolnitrin, tebufloquin, tecloftalam, tolnifanid, triazoxide, trichlamide, zarilamide, (3S,6S,7R,8R)-8-benzyl-3-[({3-[(isobutyryloxy)methoxy]-4-methoxypyridin-2-yl}carbonyl)amino]-6-methyl-4,9-dioxo-1,5-dioxonan-7-yl 2-methylpropanoate, 1-(4-{4-[(5R)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, 1-(4-{4-[(5S)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, 1-(4-{4-[5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, 1-(4-methoxyphenoxy)-3,3-dimethylbutan-2-yl 1H-imidazole-1-carboxylate, 2,3,5,6-tetrachloro-4-(methylsulfonyl)-pyridine, 2,3-dibutyl-6-chlorothieno[2,3-d]pyrimidin-4(3H)-one, 2,6-dimethyl-1H,5H-[1,4]dithiino[2,3-c:5,6-c′]dipyrrole-1,3,5,7(2H,6H)-tetrone, 2-[5-methyl-3-(trifluoromethyl)-1H-pyrazol-1-yl]-1-(4-{4-[(5R)-5-phenyl-4,5-dihydro-1,2-oxazol-3-yl]-1,3-thiazol-2-yl}-piperidin-1-yl)ethanone, 2-[5-methyl-3-(trifluoro-methyl)-1H-pyrazol-1-yl]-1-(4-{4-[(5S)-5-phenyl-4,5-dihydro-1,2-oxazol-3-yl]-1,3-thiazol-2-yl}piperidin-1-yl)ethanone, 2-[5-methyl-3-(trifluoromethyl)-1H-pyrazol-1-yl]-1-{4-[4-(5-phenyl-4,5-dihydro-1,2-oxazol-3-yl)-1,3-thiazol-2-yl]piperidin-1-yl}ethanone, 2-butoxy-6-iodo-3-propyl-4H-chromen-4-one, 2-chloro-5-[2-chloro-1-(2,6-difluoro-4-methoxyphenyl)-4-methyl-1H-imidazol-5-yl]pyridine, 2-phenylphenol and salts thereof, 3-(4,4,5-trifluoro-3,3-dimethyl-3,4-dihydroisoquinolin-1-yl) quinoline, 3,4,5-trichloro-pyridine-2,6-dicarbonitrile, 3-[5-(4-chlorophenyl)-2,3-dimethyl-1,2-oxazolidin-3-yl]pyridine, 3-chloro-5-(4-chlorophenyl)-4-(2,6-difluorophenyl)-6-methyl-pyridazine, 4-(4-chlorophenyl)-5-(2,6-difluorophenyl)-3,6-dimethylpyridazine, 5-amino-1,3,4-thiadiazole-2-thiol, 5-chloro-N′-phenyl-N′-(prop-2-yn-1-yl)thiophene-2-sulfonohydrazide, 5-fluoro-2-[(4-fluorobenzyl)oxy]-pyrimidine-4-amine, 5-fluoro-2-[(4-methylbenzyl)oxy]-pyrimidine-4-amine, 5-methyl-6-octyl[1,2,4]triazolo-[1,5-a]pyrimidine-7-amine, ethyl (2Z)-3-amino-2-cyano-3-phenylprop-2-enoate, N′-(4-{[3-(4-chlorobenzyl)-1,2,4-thiadiazol-5-yl]oxy}-2,5-dimethylphenyl)-N-ethyl-N-methylimidoformamide, N-(4-chlorobenzyl)-3-[3-methoxy-4-(prop-2-yn-1-yloxy)phenyl]propanamide, N-[(4-chlorophenyl)(cyano)methyl]-3-[3-methoxy-4-(prop-2-yn-1-yloxy)phenyl]propanamide, N-[(5-bromo-3-chloro-pyridin-2-yl)methyl]-2,4-dichloropyridine-3-carboxamide, N-[1-(5-bromo-3-chloropyridin-2-yl)ethyl]-2,4-dichloropyridine-3-carboxamide, N-[1-(5-bromo-3-chloropyridin-2-yl)ethyl]-2-fluoro-4-iodopyridine-3-carboxamide, N-{(E)-[(cyclopropylmethoxy)imino][6-(difluoromethoxy)-2,3-difluorophenyl]methyl}-2-phenylacetamide, N-{(Z)-[(cyclopropylmethoxy)imino][6-(difluoromethoxy)-2,3-difluorophenyl]methyl}-2-phenylacetamide, N′-{4-[(3-tert-butyl-4-cyano-1,2-thiazol-5-yl)oxy]-2-chloro-5-methylphenyl}-N-ethyl-N-methylimidoformamide, N-methyl-2-(1-{[5-methyl-3-(trifluoromethyl)-1H-pyrazol-1-yl]acetyl}piperidin-4-yl)-N-(1,2,3,4-tetrahydronaphthalen-1-yl)-1,3-thiazole-4-carboxamide, N-methyl-2-(1-{[5-methyl-3-(trifluoro-methyl)-1H-pyrazol-1-yl]acetyl}piperidin-4-yl)-N-[(1R)-1,2,3,4-tetrahydronaphthalen-1-yl]-1,3-thiazole-4-carboxamide, N-methyl-2-(1-{[5-methyl-3-(trifluoro-methyl)-1H-pyrazol-1-yl]acetyl}piperidin-4-yl)-N-[(1S)-1,2,3,4-tetrahydronaphthalen-1-yl]-1,3-thiazole-4-carboxamide, pentyl {6-[({[(1-methyl-1H-tetrazol-5-yl)-(phenyl)methylidene]amino}oxy)methyl]pyridin-2-yl}-carbamate, phenazine-1-carboxylic acid, quinolin-8-ol, quinolin-8-ol sulfate (2:1) and tert-butyl {6-[({[(1-methyl-1H-tetrazol-5-yl)(phenyl)methylene]amino}oxy)-methyl]pyridin-2-yl}carbamate.

(16) Further compounds, for example 1-methyl-3-(trifluoromethyl)-N-[2′-(trifluoromethyl)biphenyl-2-yl]-1H-pyrazole-4-carboxamide, N-(4′-chlorobiphenyl-2-yl)-3-(difluoromethyl)-1-methyl-1H-pyrazole-4-carboxamide, N-(2′,4′-dichlorobiphenyl-2-yl)-3-(difluoromethyl)-1-methyl-1H-pyrazole-4-carboxamide, 3-(difluoromethyl)-1-methyl-N-[4′-(trifluoromethyl)-biphenyl-2-yl]-1H-pyrazole-4-carboxamide, N-(2′,5′-difluorobiphenyl-2-yl)-1-methyl-3-(trifluoromethyl)-1H-pyrazole-4-carboxamide, 3-(difluoromethyl)-1-methyl-N-[4′-(prop-1-yn-1-yl)biphenyl-2-yl]-1H-pyrazole-4-carboxamide, 5-fluoro-1,3-dimethyl-N-[4′-(prop-1-yn-1-yl)biphenyl-2-yl]-1H-pyrazole-4-carboxamide, 2-chloro-N-[4′-(prop-1-yn-1-yl)biphenyl-2-yl]pyridine-3-carboxamide, 3-(difluoromethyl)-N-[4′-(3,3-dimethylbut-1-yn-1-yl)biphenyl-2-yl]-1-methyl-1H-pyrazole-4-carboxamide, N-[4′-(3,3-dimethylbut-1-yn-1-yl)biphenyl-2-yl]-5-fluoro-1,3-dimethyl-1H-pyrazole-4-carboxamide, 3-(difluoromethyl)-N-(4′-ethynylbiphenyl-2-yl)-1-methyl-1H-pyrazole-4-carboxamide, N-(4′-ethynyl-biphenyl-2-yl)-5-fluoro-1,3-dimethyl-1H-pyrazole-4-carboxamide, 2-chloro-N-(4′-ethynylbiphenyl-2-yl)-pyridine-3-carboxamide, 2-chloro-N-[4′-(3,3-dimethylbut-1-yn-1-yl)biphenyl-2-yl]pyridine-3-carboxamide, 4-(difluoromethyl)-2-methyl-N-[4′-(trifluoromethyl)biphenyl-2-yl]-1,3-thiazole-5-carboxamide, 5-fluoro-N-[4′-(3-hydroxy-3-methylbut-1-yn-1-yl)biphenyl-2-yl]-1,3-dimethyl-1H-pyrazole-4-carboxamide, 2-chloro-N-[4′-(3-hydroxy-3-methylbut-1-yn-1-yl)biphenyl-2-yl]pyridine-3-carboxamide, 3-(difluoromethyl)-N-[4′-(3-methoxy-3-methylbut-1-yn-1-yl)biphenyl-2-yl]-1-methyl-1H-pyrazole-4-carboxamide, 5-fluoro-N-[4′-(3-methoxy-3-methylbut-1-yn-1-yl)-biphenyl-2-yl]-1,3-dimethyl-1H-pyrazole-4-carboxamide, 2-chloro-N-[4′-(3-methoxy-3-methylbut-1-yn-1-yl)-biphenyl-2-yl] pyridine-3-carboxamide, (5-bromo-2-methoxy-4-methylpyridin-3-yl) (2,3,4-trimethoxy-6-methylphenyl)methanone, N-[2-(4-{[3-(4-chlorophenyl)-prop-2-yn-1-yl]oxy}-3-methoxyphenyl)ethyl]-N2-(methylsulfonyl)valinamide, 4-oxo-4-[(2-phenylethyl)-amino]butanoic acid and but-3-yn-1-yl {6-[({[(Z)-(1-methyl-1H-tetrazol-5-yl)(phenyl)methylene]amino}oxy)-methyl]pyridin-2-yl}carbamate.

Examples of bactericides include:

bronopol, dichlorophen, nitrapyrin, nickel dimethyldithiocarbamate, kasugamycin, octhilinone, furancarboxylic acid, oxytetracyclin, probenazole, streptomycin, tecloftalam, copper sulfate and other copper preparations.

Examples of insecticides, acaricides and nematicides include:

(1) Acetylcholinesterase (AChE) inhibitors, such as carbamates, e.g. alanycarb, aldicarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, triazamate, trimethacarb, XMC and xylylcarb; or organophosphates, e.g. acephate, azamethiphos, azinphos-ethyl, azinphos-methyl, cadusafos, chlorethoxyfos, chlorfenvinphos, chlormephos, chlorpyrifos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, imicyafos, isofenphos, isopropyl O-(methoxyaminothiophosphoryl) salicylate, isoxathion, malathion, mecarbam, methamidophos, methidathion, mevinphos, monocrotophos, naled, omethoate, oxydemeton-methyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, triclorfon and vamidothion.

(2) GABA-gated chloride channel antagonists, for example cyclodiene-organochlorines, e.g. chlordane and endosulfan; or phenylpyrazoles (fiproles), e.g. ethiprole and fipronil.

(3) Sodium channel modulators/voltage-gated sodium channel blockers, for example pyrethroids, e.g. acrinathrin, allethrin, d-cis-trans allethrin, d-trans allethrin, bifenthrin, bioallethrin, bioallethrin S-cyclopentenyl isomer, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin [(1R)-trans isomers], deltamethrin, empenthrin [(EZ)-(1R) isomers], esfenvalerate, etofenprox, fenpropathrin, fenvalerate, flucythrinate, flumethrin, tau-fluvalinate, halfenprox, imiprothrin, kadethrin, permethrin, phenothrin [(1R)-trans isomer], prallethrin, pyrethrins (pyrethrum), resmethrin, silafluofen, tefluthrin, tetramethrin, tetramethrin [(1R) isomers)], tralomethrin and transfluthrin; or DDT; or methoxychlor.

(4) Nicotinergic acetylcholine receptor (nAChR) agonists, for example neonicotinoids, e.g. acetamiprid, clothianidin, dinotefuran, imidacloprid, nitenpyram, thiacloprid and thiamethoxam; or nicotine.

(5) Allosteric activators of the nicotinergic acetylcholine receptor (nAChR), for example spinosyns, e.g. spinetoram and spinosad.

(6) Chloride channel activators, for example avermectins/milbemycins, e.g. abamectin, emamectin benzoate, lepimectin and milbemectin.

(7) Juvenile hormone imitators, for example juvenile hormone analogs e.g. hydroprene, kinoprene and methoprene; or fenoxycarb; or pyriproxyfen.

(8) Active ingredients with unknown or nonspecific mechanisms of action, for example alkyl halides, e.g. methyl bromide and other alkyl halides; or chloropicrin; or sulfuryl fluoride; or borax; or tartar emetic.

(9) Selective antifeedants, e.g. pymetrozine; or flonicamid.

(10) Mite growth inhibitors, e.g. clofentezine, hexythiazox and diflovidazin; or etoxazole.

(11) Microbial disruptors of the insect gut membrane, e.g. Bacillus thuringiensis subspecies israelensis, Bacillus sphaericus, Bacillus thuringiensis subspecies aizawai, Bacillus thuringiensis subspecies kurstaki, Bacillus thuringiensis subspecies tenebrionis, and BT plant proteins: Cry1Ab, Cry1Ac, Cry1Fa, Cry2Ab, mCry3A, Cry3Ab, Cry3Bb, Cry34/35Ab1.

(12) Oxidative phosphorylation inhibitors, ATP disruptors, for example diafenthiuron; or organotin compounds, e.g. azocyclotin, cyhexatin and fenbutatin oxide; or propargite; or tetradifon.

(13) Oxidative phosphorylation decouplers that interrupt the H proton gradient, for example chlorfenapyr, DNOC and sulfluramid.

(14) Nicotinergic acetylcholine receptor antagonists, for example bensultap, cartap hydrochloride, thiocyclam, and thiosultap-sodium.

(15) Chitin biosynthesis inhibitors, type 0, for example bistrifluron, chlorfluazuron, diflubenzuron, flucycloxuron, flufenoxuron, hexaflumuron, lufenuron, novaluron, noviflumuron, teflubenzuron and triflumuron.

(16) Chitin biosynthesis inhibitors, type 1, for example buprofezin.

(17) Moulting disruptors, dipteran, for example cyromazine.

(18) Ecdysone receptor agonists, for example chromafenozide, halofenozide, methoxyfenozide and tebufenozide.

(19) Octopaminergic agonists, for example amitraz.

(20) Complex-III electron transport inhibitors, for example hydramethylnon; or acequinocyl; or fluacrypyrim.

(21) Complex-I electron transport inhibitors, for example METI acaricides, e.g. fenazaquin, fenpyroximate, pyrimidifen, pyridaben, tebufenpyrad and tolfenpyrad; or rotenone (Derris).

(22) Voltage-gated sodium channel blockers, for example indoxacarb; or metaflumizone.

(23) Inhibitors of acetyl-CoA carboxylase, for example tetronic and tetramic acid derivatives, e.g. spirodiclofen, spiromesifen and spirotetramat.

(24) Complex-IV electron transport inhibitors, for example phosphines, e.g. aluminum phosphide, calcium phosphide, phosphine and zinc phosphide; or cyanide.

(25) Complex-II electron transport inhibitors, for example cyenopyrafen.

(28) Ryanodine receptor effectors, for example diamides, e.g. chlorantraniliprole and flubendiamide.

Further active ingredients with an unknown mechanism of action, for example amidoflumet, azadirachtin, benclothiaz, benzoximate, bifenazate, bromopropylate, chinomethionat, cryolite, cyantraniliprole (Cyazypyr), cyflumetofen, dicofol, diflovidazin, fluensulfone, flufenerim, flufiprole, fluopyram, fufenozide, imidaclothiz, iprodione, pyridalyl, pyrifluquinazon and iodomethane; and additionally preparations based on Bacillus firmus (I-1582, BioNeem, Votivo).

Examples of herbicides include:

acetochlor, acibenzolar, acibenzolar-S-methyl, acifluorfen, acifluorfen-sodium, aclonifen, alachlor, allidochlor, alloxydim, alloxydim-sodium, ametryn, amicarbazone, amidochlor, amidosulfuron, aminocyclopyrachlor, aminocyclopyrachlor-potassium, aminocyclopyrachlor-methyl, aminopyralid, amitrole, ammonium sulfamate, ancymidol, anilofos, asulam, atrazine, aviglycine, azafenidin, azimsulfuron, aziprotryne, beflubutamid, benazolin, benazolin-ethyl, bencarbazone, benfluralin, benfuresate, bensulide, bensulfuron, bensulfuron-methyl, bentazone, benzfendizone, benzobicyclon, benzofenap, benzofluor, benzoylprop, benzyladenine, bicyclopyrone, bifenox, bilanafos, bilanafos-sodium, bispyribac, bispyribac-sodium, bromacil, bromobutide, bromofenoxim, bromoxynil, bromuron, buminafos, busoxinone, butachlor, butafenacil, butamifos, butenachlor, butralin, butroxydim, butylate, cafenstrole, carbaryl, carbetamide, carfentrazone, carfentrazone-ethyl, carvone, chlorocholine chloride, chlomethoxyfen, chloramben, chlorazifop, chlorazifop-butyl, chlorbromuron, chlorbufam, chlorfenac, chlorfenac-sodium, chlorfenprop, chlorflurenol, chlorflurenol-methyl, chloridazon, chlorimuron, chlorimuron-ethyl, chlormequat-chloride, chlornitrofen, 4-chlorophenoxy-acetic acid, chlorophthalim, chlorpropham, chlorthal-dimethyl, chlortoluron, chlorsulfuron, cinidon, cinidon-ethyl, cinmethylin, cinosulfuron, clethodim, clodinafop, clodinafop-propargyl, clofencet, clomazone, clomeprop, cloprop, clopyralid, cloransulam, cloransulam-methyl, cloxyfonac, cumyluron, cyanamide, cyanazine, cyclanilide, cycloate, cyclosulfamuron, cycloxydim, cycluron, cyhalofop, cyhalofop-butyl, cyperquat, cyprazine, cyprazole, cytokinine, 2,4-D, 2,4-DB, daimuron/dymron, dalapon, daminozide, dazomet, n-decanol, desmedipham, desmetryn, detosyl-pyrazolate (DTP), diallate, diaminozide, dicamba, dichlobenil, dichlorprop, dichlorprop-P, diclofop, diclofop-methyl, diclofop-P-methyl, diclosulam, diethatyl, diethatyl-ethyl, difenoxuron, difenzoquat, diflufenican, diflufenzopyr, diflufenzopyr-sodium, dikegulac-sodium, dimefuron, dimepiperate, dimethachlor, dimethametryn, dimethenamid, dimethenamid-P, dimethipin, dimetrasulfuron, dinitramine, dinoseb, dinoterb, diphenamid, diisopropylnaphthalene, dipropetryn, diquat, diquat-dibromide, dithiopyr, diuron, DNOC, eglinazine-ethyl, endothal, EPTC, esprocarb, ethalfluralin, ethametsulfuron, ethametsulfuron-methyl, ethyl naphthylacetate, ethephon, ethidimuron, ethiozin, ethofumesate, ethoxyfen, ethoxyfen-ethyl, ethoxysulfuron, etobenzanid, F-5331, i.e. N-[2-chloro-4-fluoro-5-[4-(3-fluoropropyl)-4,5-dihydro-5-oxo-1H-tetrazol-1-yl]phenyl]ethanesulfonamide, F-7967, i.e. 3-[7-chloro-5-fluoro-2-(trifluoromethyl)-1H-benzimidazol-4-yl]-1-methyl-6-(trifluoromethyl)pyrimidine-2,4(1H,3H)-dione, fenoprop, fenoxaprop, fenoxaprop-P, fenoxaprop-ethyl, fenoxaprop-P-ethyl, fenoxasulfone, fentrazamide, fenuron, flamprop, flamprop-M-isopropyl, flamprop-M-methyl, flazasulfuron, florasulam, fluazifop, fluazifop-P, fluazifop-butyl, fluazifop-P-butyl, fluazolate, flucarbazone, flucarbazone-sodium, flucetosulfuron, fluchloralin, flufenacet (thiafluamide), flufenpyr, flufenpyr-ethyl, flumetralin, flumetsulam, flumiclorac, flumiclorac-pentyl, flumioxazin, flumipropyn, fluometuron, fluorodifen, fluoroglycofen, fluoroglycofen-ethyl, flupoxam, flupropacil, flupropanate, flupyrsulfuron, flupyrsulfuron-methyl-sodium, flurenol, flurenol-butyl, fluridone, flurochloridone, fluroxypyr, fluroxypyr-meptyl, flurprimidol, flurtamone, fluthiacet, fluthiacet-methyl, fluthiamide, fomesafen, foramsulfuron, forchlorfenuron, fosamine, furyloxyfen, gibberellic acid, glufosinate, glufosinate-ammonium, glufosinate-P, glufosinate-P-ammonium, glufosinate-P-sodium, glyphosate, glyphosate-isopropylammonium, H-9201, i.e. O-(2,4-dimethyl-6-nitrophenyl) O-ethyl isopropylphosphoramidothioate, halosafen, halosulfuron, halosulfuron-methyl, haloxyfop, haloxyfop-P, haloxyfop-ethoxyethyl, haloxyfop-P-ethoxyethyl, haloxyfop-methyl, haloxyfop-P-methyl, hexazinone, HW-02, i.e. 1-(dimethoxyphosphoryl) ethyl (2,4-dichlorophenoxy)-acetate, imazamethabenz, imazamethabenz-methyl, imazamox, imazamox-ammonium, imazapic, imazapyr, imazapyr-isopropylammonium, imazaquin, imazaquin-ammonium, imazethapyr, imazethapyr-ammonium, imazosulfuron, inabenfide, indanofan, indaziflam, indoleacetic acid (IAA), 4-indol-3-ylbutyric acid (IBA), iodosulfuron, iodosulfuron-methyl-sodium, iofensulfuron, iofensulfuron-sodium, ioxynil, ipfencarbazone, isocarbamid, isopropalin, isoproturon, isouron, isoxaben, isoxachlortole, isoxaflutole, isoxapyrifop, KUH-043, i.e. 3-({[5-(difluoromethyl)-1-methyl-3-(trifluoromethyl)-1H-pyrazol-4-yl]methyl}-sulfonyl)-5,5-dimethyl-4,5-dihydro-1,2-oxazole, karbutilate, ketospiradox, lactofen, lenacil, linuron, maleic hydrazide, MCPA, MCPB, MCPB-methyl, -ethyl and -sodium, mecoprop, mecoprop-sodium, mecoprop-butotyl, mecoprop-P-butotyl, mecoprop-P-dimethylammonium, mecoprop-P-2-ethylhexyl, mecoprop-P-potassium, mefenacet, mefluidide, mepiquat-chloride, mesosulfuron, mesosulfuron-methyl, mesotrione, methabenzthiazuron, metam, metamifop, metamitron, metazachlor, metazasulfuron, methazole, methiopyrsulfuron, methiozolin, methoxyphenone, methyldymron, 1-methylcyclopropene, methyl isothiocyanate, metobenzuron, metobromuron, metolachlor, S-metolachlor, metosulam, metoxuron, metribuzin, metsulfuron, metsulfuron-methyl, molinate, monalide, monocarbamide, monocarbamide dihydrogensulfate, monolinuron, monosulfuron, monosulfuron ester, monuron, MT-128, i.e. 6-chloro-N-[(2E)-3-chloroprop-2-en-1-yl]-5-methyl-N-phenylpyridazine-3-amine, MT-5950, i.e. N-[3-chloro-4-(1-methylethyl)phenyl]-2-methylpentanamide, NGGC-011, 1-naphthylacetic acid (NAA), naphthylacetamide (NAAm), 2-naphthoxyacetic acid, naproanilide, napropamide, naptalam, NC-310, i.e. 4-(2,4-dichlorobenzoyl)-1-methyl-5-benzyloxypyrazole, neburon, nicosulfuron, nipyraclofen, nitralin, nitrofen, nitroguaiacolate, nitrophenolate-sodium (isomer mixture), nitrofluorfen, nonanoic acid, norflurazon, orbencarb, orthosulfamuron, oryzalin, oxadiargyl, oxadiazon, oxasulfuron, oxaziclomefone, oxyfluorfen, paclobutrazole, paraquat, paraquat dichloride, pelargonic acid (nonanoic acid), pendimethalin, pendralin, penoxsulam, pentanochlor, pentoxazone, perfluidone, pethoxamid, phenisopham, phenmedipham, phenmedipham-ethyl, picloram, picolinafen, pinoxaden, piperophos, pirifenop, pirifenop-butyl, pretilachlor, primisulfuron, primisulfuron-methyl, probenazole, profluazole, procyazine, prodiamine, prifluraline, profoxydim, prohexadione, prohexadione-calcium, prohydrojasmone, prometon, prometryn, propachlor, propanil, propaquizafop, propazine, propham, propisochlor, propoxycarbazone, propoxycarbazone-sodium, propyrisulfuron, propyzamide, prosulfalin, prosulfocarb, prosulfuron, prynachlor, pyraclonil, pyraflufen, pyraflufen-ethyl, pyrasulfotole, pyrazolynate (pyrazolate), pyrazosulfuron, pyrazosulfuron-ethyl, pyrazoxyfen, pyribambenz, pyribambenz-isopropyl, pyribambenz-propyl, pyribenzoxim, pyributicarb, pyridafol, pyridate, pyriftalid, pyriminobac, pyriminobac-methyl, pyrimisulfan, pyrithiobac, pyrithiobac-sodium, pyroxasulfone, pyroxsulam, quinclorac, quinmerac, quinoclamine, quizalofop, quizalofop-ethyl, quizalofop-P, quizalofop-P-ethyl, quizalofop-P-tefuryl, rimsulfuron, saflufenacil, secbumeton, sethoxydim, siduron, simazine, simetryn, SN-106279, i.e. methyl (2R)-2-({7-[2-chloro-4-(trifluoromethyl)phenoxy]-2-napthyl}oxy)propanoate, sulcotrione, sulfallate (CDEC), sulfentrazone, sulfometuron, sulfometuron-methyl, sulfosate (glyphosate-trimesium), sulfosulfuron, SW-065, SYN-523, SYP-249, i.e. 1-ethoxy-3-methyl-1-oxobut-3-en-2-yl 5-[2-chloro-4-(trifluoro-methyl)phenoxy]-2-nitrobenzoate, SYP-300, i.e. 1-[7-fluoro-3-oxo-4-(prop-2-yn-1-yl)-3,4-dihydro-2H-1,4-benzoxazin-6-yl]-3-propyl-2-thioxoimidazolidine-4,5-dione, tebutam, tebuthiuron, tecnazene, tefuryltrione, tembotrione, tepraloxydim, terbacil, terbucarb, terbuchlor, terbumeton, terbuthylazine, terbutryne, thenylchlor, thiafluamide, thiazafluron, thiazopyr, thidiazimin, thidiazuron, thiencarbazone, thiencarbazone-methyl, thifensulfuron, thifensulfuron-methyl, thiobencarb, tiocarbazil, topramezone, tralkoxydim, triafamone, triallate, triasulfuron, triaziflam, triazofenamide, tribenuron, tribenuron-methyl, tribufos, trichloroacetic acid (TCA), triclopyr, tridiphane, trietazine, trifloxysulfuron, trifloxysulfuron-sodium, trifluralin, triflusulfuron, triflusulfuron-methyl, trimeturon, trinexapac, trinexapac-ethyl, tritosulfuron, tsitodef, uniconazole, uniconazole-P and vernolate, ZJ-0862, i.e. 3,4-dichloro-N-{2-[(4,6-dimethoxypyrimidin-2-yl)oxy]benzyl}aniline, and the following compounds:

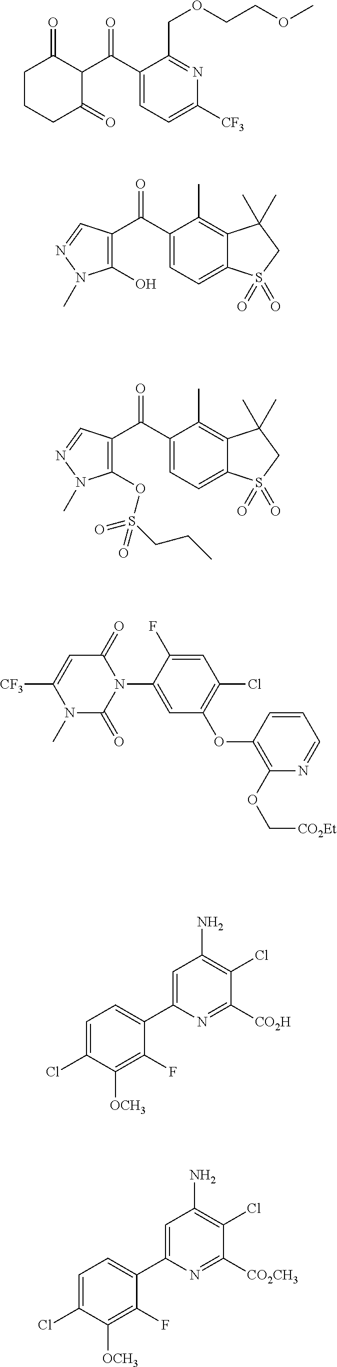 [SMILES: COCCOCc1nc(C(F)(F)F)ccc1C(=O)C1C(=O)CCCC1=O ; Cc1c(C(=O)c2cnn(C)c2O)ccc2c1C(C)(C)CS2(=O)=O ; CCCS(=O)(=O)Oc1c(C(=O)c2ccc3c(c2C)C(C)(C)CS3(=O)=O)cnn1C ; CCOC(=O)COc1ncccc1Oc1cc(-n2c(=O)cc(C(F)(F)F)n(C)c2=O)c(F)cc1Cl ; COc1c(Cl)ccc(-c2cc(N)c(Cl)c(C(=O)O)n2)c1F ; COC(=O)c1nc(-c2ccc(Cl)c(OC)c2F)cc(N)c1Cl]

Phytohormones control physiological reactions, such as growth, flowering rhythm, cell division and seed ripening. Examples of growth regulators include natural and synthetic plant hormones such as abscisic acid, benzyladenine, caprylic acid, decanol, indoleacetic acid, jasmonic acid and esters thereof, salicylic acid and esters thereof, gibberellic acid, kinetin and brassinosteroids.

Biological control agents are known to those skilled in the art and are described, for example, in “The Manual of Biocontrol Agents: A World Compendium, Copping, L. G., BCPC 2009”.

Examples of plant nutrients include customary inorganic or organic fertilizers for supplying plants with macro- and/or micronutrients.

Examples of repellents include diethyltolylamide, ethylhexanediol and butopyronoxyl.

The agrochemical substances are preferably selected from the group consisting of herbicides, insecticides, fungicides and growth regulators. More preferably, the agrochemical substances are selected from the group consisting of herbicides and growth regulators.

Preferred fungicides are aliphatic nitrogen fungicides, amide fungicides such as acyl amino acid fungicides or anilide fungicides or benzamide fungicides or strobilurin fungicides, aromatic fungicides, benzimidazole fungicides, benzothiazole fungicides, carbamate fungicides, conazole fungicides such as imidazoles or triazoles, dicarboximide fungicides, dithiocarbamate fungicides, imidazole fungicides, morpholine fungicides, oxazole fungicides, pyrazole fungicides, pyridine fungicides, pyrimidine fungicides, pyrrole fungicides, quinone fungicides and spiroketalamines. More preferably, the fungicides are selected from the group consisting of morpholine fungicides, preferably fenpropidin or fenpropimorph, and spiroketalamines, preferably spiroxamine. These fungicides are notable particularly for a high human toxicity in sublethal doses.

Preferred insecticides are carbamate insecticides such as benzofuranylmethyl carbamate insecticides or dimethyl carbamate insecticides or oxime carbamate insecticides or phenyl methylcarbamate insecticides, diamide insecticides, insect growth regulators, macrocyclic lactone insecticides such as avermectin insecticides or milbemycin insecticides or spinosyn insecticides, nereistoxin analog insecticides, neonicotinoids, nicotinoid insecticides such as nitroguanidine nicotinoid insecticides or pyridylmethylamine nicotinoid insecticides, organophosphorus insecticides such as organophosphate insecticides or organothiophosphate insecticides or phosphonate insecticides or phosphoramidothioate insecticides, oxadiazine insecticides, pyrazole insecticides, pyrethroid insecticides such as pyrethroid ester insecticides or pyrethroid ether insecticides or pyrethroid oxime insecticides, tetramic acid insecticides, tetrahydrofurandione insecticides, thiazole insecticides. More preferably, the insecticides are selected from the group consisting of organophosphorus insecticides, preferably dimethoate, and neonicotinoids. These insecticides are notable particularly for a high toxicity to useful organisms and bees in sublethal doses.

Preferred herbicides are amide herbicides, anilide herbicides, aromatic acid herbicides such as benzoic acid herbicides or picolinic acid herbicides, benzoylcyclohexanedione herbicides, benzofuranyl alkylsulfonate herbicides, benzothiazole herbicides, carbamate herbicides, carbanilate herbicides, cyclohexene oxime herbicides, cyclopropylisoxazole herbicides, dicarboximide herbicides, dinitroaniline herbicides, dinitrophenol herbicides, diphenyl ether herbicides, dithiocarbamate herbicides, glycine derivative herbicides, imidazolinone herbicides, isoxazole herbicides, isoxazolidinone herbicides, nitrile herbicides, organophosphorus herbicides, oxadiazolone herbicides, oxazole herbicides, phenoxy herbicides such as phenoxyacetic acid herbicides or phenoxybutanoic acid herbicides or phenoxypropionic acid herbicides or aryloxyphenoxypropionic acid herbicides, phenylpyrazoline herbicides, pyrazole herbicides such as benzoylpyrazole herbicides or phenylpyrazole herbicides, pyridazinone herbicides, pyridine herbicides, pyrimidinedione herbicides, thiocarbamate herbicides, triazine herbicides, triazinone herbicides, triazole herbicides, triazolone herbicides, triazolopyrimidine herbicides, triketone herbicides, uracil herbicides, urea herbicides such as phenylurea herbicides or sulfonylurea herbicides. More preferably, the herbicides are selected from the group consisting of benzoic acid herbicides, preferably dicamba or salts thereof, cyclohexene oxime herbicides, preferably clethodim, diphenyl ether herbicides, preferably aclonifen, isoxazolidinone herbicides, preferably clomazone, and phenoxy herbicides, preferably 2,4-D or the salts and esters thereof. These herbicides are notable particularly for a high plant toxicity to non-target plants in sublethal doses.

Preferred growth regulators are natural and synthetic plant hormones selected from the group consisting of alcohols, preferably decanol, auxins, preferably indoleacetic acid, cytokinins, preferably benzyladenine, fatty acids, preferably caprylic acid, gibberellins, preferably gibberellic acid, jasmonates, preferably jasmonic acid or esters thereof, sesquiterpenes, preferably abscisic acid, and salicylic acid or esters thereof.

Especially preferably, the one or more agrochemical substances are one or more pesticides selected from the group consisting of aclonifen, clethodim, 2,4-D or salts or esters thereof, dicamba or salts thereof, dimethoate, fenpropidin, fenpropimorph and spiroxamine. These pesticides are notable for a high volatility (vapor pressure greater than 10⁻⁵ Pa) and for a high toxicity to humans, useful organisms, bees or non-target plants.

Standard formulation forms for crop treatment compositions are, for example, water-soluble liquids (SL), emulsion concentrates (EC), emulsions in water (EW), suspension concentrates (SC, SE, FS, OD), water-dispersible granules (WG), granules (GR) and capsule concentrates (CS); these and further possible formulation types are described, for example, by Crop Life International and in Pesticide Specifications, Manual on development and use of FAO and WHO specifications for pesticides, FAO Plant Production and Protection Papers—173, prepared by the FAO/WHO Joint Meeting on Pesticide Specifications, 2004, ISBN: 9251048576.

The crop treatment compositions may optionally contain action-improving adjuvants. An adjuvant in this context is a component which enhances the biological effect of the formulation, without the component itself having any biological effect. Examples of adjuvants are penetrants, for example vegetable oils, for example rapeseed oil, sunflower oil, mineral oils, for example paraffin oils, alkyl esters of vegetable fatty acids, for example rapeseed oil methyl ester or soya oil methyl ester, or alkanol alkoxylates and/or spreaders, for example alkylsiloxanes and/or salts, for example organic or inorganic ammonium or phosphonium salts, for example ammonium sulfate or diammonium hydrogenphosphate and/or retention promoters, for example dioctyl sulfosuccinate or hydroxypropylguar polymers and/or humectants, for example glycerol and/or fertilizers, for example ammonium-, potassium- or phosphorus-containing fertilizers and/or agents which promote sticking to the leaf surface.

Optionally, the crop treatment compositions may contain auxiliaries, preferably in combination with the abovementioned adjuvants. The auxiliaries may, for example, be extenders, solvents, spontaneity promoters, carriers, emulsifiers, dispersants, antifreezes, biocides and/or thickeners.

The crop treatment compositions are produced in a known manner, for example by mixing the active ingredients with auxiliaries, for example extenders, solvents and/or solid carriers and/or further auxiliaries, for example surfactants. The crop treatment compositions are produced as formulations either in suitable facilities or else before or during application.

Auxiliaries used may be those substances which are suitable for imparting particular properties, such as particular physical, technical and/or biological properties, to the formulation of the active ingredient or to the use forms prepared from these formulations (for example ready-to-use crop protection compositions such as spray liquors or seed dressing products).

Suitable extenders are, for example, water, polar and nonpolar organic chemical liquids, for example from the classes of the aromatic and nonaromatic hydrocarbons (such as paraffins, alkylbenzenes, alkylnaphthalenes, chlorobenzenes), the alcohols and polyols (which may optionally also be substituted, etherified and/or esterified), the ketones (such as acetone, cyclohexanone), esters (including fats and oils) and (poly)ethers, the unsubstituted and substituted amines, amides, lactams (such as N-alkylpyrrolidones) and lactones, the sulfones and sulfoxides (such as dimethyl sulfoxide).

In principle, it is possible to use any suitable solvents. Examples of suitable solvents are aromatic hydrocarbons, for example xylene, toluene or alkylnaphthalenes, chlorinated aromatic or aliphatic hydrocarbons, for example chlorobenzene, chloroethylene or methylene chloride, aliphatic hydrocarbons, for example cyclohexane, paraffins, mineral oil fractions, mineral and vegetable oils, alcohols, for example methanol, ethanol, isopropanol, butanol or glycol and the ethers and esters thereof, ketones, for example acetone, methyl ethyl ketone, methyl isobutyl ketone or cyclohexanone, strongly polar solvents such as dimethylformamide and dimethyl sulfoxide, and also water.

In principle, it is possible to use any suitable carriers. Useful carriers especially include: for example ammonium salts and natural rock flour such as kaolins, aluminas, talc, chalk, quartz, attapulgite, montmorillonite or diatomaceous earth, and synthetic rock flour such as finely divided silica, aluminum oxide and natural or synthetic silicates, resins, waxes and/or solid fertilizers. It is likewise possible to use mixtures of such carriers. Useful carriers for granules include: for example crushed and fractionated natural rocks such as calcite, marble, pumice, sepiolite, dolomite, and synthetic granules of inorganic and organic flours, and also granules of organic material such as sawdust, paper, coconut shells, corn cobs and tobacco stalks.

It is also possible to use liquefied gaseous extenders or solvents. Especially suitable are those extenders or carriers which are gaseous at standard temperature and under standard pressure, for example aerosol propellants such as halohydrocarbons, or else butane, propane, nitrogen and carbon dioxide.

Examples of emulsifiers and/or foam formers, dispersants or wetting agents with ionic or nonionic properties, or mixtures of these surfactants, are salts of polyacrylic acid, salts of lignosulfonic acid, salts of phenolsulfonic acid or naphthalenesulfonic acid, polycondensates of ethylene oxide with fatty alcohols or with fatty acids or with fatty amines, with substituted phenols (preferably alkylphenols or arylphenols), salts of sulfosuccinic esters, taurine derivatives (preferably alkyl taurates), phosphoric esters of polyethoxylated alcohols or phenols, fatty acid esters of polyols, and derivatives of the compounds containing sulfates, sulfonates and phosphates, for example alkylaryl polyglycol ethers, alkyl sulfonates, alkyl sulfates, arylsulfonates, protein hydrolyzates, lignosulfite waste liquors and methyl cellulose. The presence of a surfactant is advantageous when one of the active ingredients and/or one of the inert carriers is insoluble in water and when application is effected in water.

Further auxiliaries which may be present in the formulations and the use forms derived therefrom are dyes such as inorganic pigments, for example iron oxide, titanium oxide and Prussian Blue, and organic dyes such as alizarin dyes, azo dyes and metal phthalocyanine dyes, and nutrients and trace nutrients such as salts of iron, manganese, boron, copper, cobalt, molybdenum and zinc.

Additional components may be stabilizers, such as cold stabilizers, preservatives, antioxidants, light stabilizers, or other agents which improve chemical and/or physical stability. In addition, foam formers or defoamers may be present.

In addition, the formulations and the use forms derived therefrom may also comprise, as additional auxiliaries, stickers such as carboxymethyl cellulose and natural and synthetic polymers in the form of powders, granules or latices, such as gum arabic, polyvinyl alcohol and polyvinyl acetate, or else natural phospholipids such as cephalins and lecithins and synthetic phospholipids. Further possible auxiliaries are mineral and vegetable oils.

It is possible if appropriate for still further auxiliaries to be present in the formulations and the use forms derived therefrom. Examples of such additives are fragrances, protective colloids, binders, adhesives, thickeners, thixotropic agents, penetrants, retention promoters, stabilizers, sequestrants, complexing agents, humectants, spreaders.

In general, the agrochemical substances can be combined with any solid or liquid additive which is commonly used for formulation purposes.

Useful retention promoters include all those substances which reduce dynamic surface tension, for example dioctyl sulfosuccinate, or increase viscoelasticity, for example hydroxypropylguar polymers.

Useful penetrants in the present context are all those substances which are typically used to improve the penetration of agrochemical substances into plants.

Penetrants are defined in this context by their ability to penetrate from the (generally aqueous) application liquor and/or from the spray coating into the cuticle of the plant and hence increase the mobility of active ingredients in the cuticle. The method described in the literature (Baur et al., 1997, Pesticide Science 51, 131-152) can be used to determine this property. Examples include alcohol alkoxylates, for example coconut fat ethoxylate (10) or isotridecyl ethoxylate (12), fatty acid esters, for example rapeseed oil methyl ester or soya oil methyl ester, fatty amine alkoxylates, for example tallowamine ethoxylate (15) or ammonium salts and/or phosphonium salts, for example ammonium sulfate or diammonium hydrogenphosphate.

The crop treatment compositions contain preferably between 0.00000001% and 98% by weight of agrochemical substances or, more preferably between 0.01% and 95% by weight of agrochemical substances, more preferably between 0.5% and 90% by weight of agrochemical substances, based on the weight of the crop treatment compositions.

The content of agrochemical substances in the use forms (crop protection compositions) prepared from the crop treatment compositions can vary within wide limits. The concentration of the agrochemical substances in the use forms, especially in the spray liquors, may typically be between 0.00000001% and 95% by weight of agrochemical substance, preferably between 0.00001% and 5% by weight of agrochemical substance, more preferably between 0.00001% and 1% by weight of agrochemical substance and especially preferably between 0.001% and 1% by weight of agrochemical substance, based on the weight of the use form, especially of the spray liquor. Application is accomplished in a customary manner appropriate to the use forms.

The formulations are produced, for example, by mixing the components with one another in the particular ratios desired. If the agrochemical substance is a solid substance, it is generally used either in finely ground form or in the form of a solution or suspension in an organic solvent or water. If the agrochemical substance is liquid, there is frequently no need to use an organic solvent. It is also possible to use a solid agrochemical substance in the form of a melt. The temperatures can be varied within a particular range in the course of performance of the process. In general, working temperatures are between 0° C. and 80° C., preferably between 10° C. and 60° C.

According to the formulation type, the production of the crop treatment compositions used in accordance with the invention is possible in various ways which are sufficiently well known to those skilled in the art. The procedure in the production may, for example, be to mix the etherified lactate esters of the formula (I) with one or more agrochemical substances and optionally with auxiliaries. The sequence in which the components are mixed with one another is arbitrary. Useful equipment in the production is customary equipment which is used for production of agrochemical formulations.

In the use of the invention, crop treatment compositions are deployed in the form of spray liquors. This preferably involves production of a spray liquor by dilution of a concentrate formulation with a defined amount of water.

The invention further provides a method for reducing drift on application of crop treatment compositions, wherein a preferably aqueous spray liquor is sprayed onto the plants to be treated or the locus thereof, the spray liquor comprising agrochemical substances contains one or more etherified lactate esters of the formula (I) and the amount of the one or more etherified lactate esters of the formula (I) in the spray liquor is preferably from 0.001% to 5% by weight, more preferably from 0.005% to 3% by weight, especially preferably from 0.01% to 1% by weight and exceptionally preferably from 0.03% to 0.5% by weight, based in each case on the total weight of the spray liquor.

The invention further provides compositions for reducing drift on application of crop treatment compositions containing one or more of the etherified lactate esters of the formula (I) described above and preferably spray liquors containing one or more of the etherified lactate esters of the formula (I) described above, wherein the amount of the one or more etherified lactate esters of the formula (I) in the spray liquor is preferably from 0.001% to 5% by weight, more preferably from 0.005% to 3% by weight, especially preferably from 0.01% to 1% by weight and exceptionally preferably from 0.03% to 0.5% by weight, based in each case on the total weight of the spray liquor.

### EXAMPLES

The invention is illustrated hereinafter by examples, but these should in no way be regarded as a restriction.

The percentages stated hereinafter are percent by weight (% by weight), unless explicitly stated otherwise.

The raw materials used are:
Galaster EHL 2-ethylhexyl lactate, from Galactic
PURASOLV® LL lauryl lactate, from PURAC
cetyl lactate hexadecyl lactate, from Galactic
IRGANOX® 1076 octadecyl 3-(3,5-di-tert-butyl-4-hydroxyphenyl)propionate (BASF SE)
DMC catalyst catalyst for the alkylene oxide addition, double metal cyanide catalyst comprising zinc hexacyanocobaltate, tert-butanol and polypropylene glycol having a number-average molecular weight of 1000 g/mol; described in WO-A-01/80994, example 6
Synergen® OS anti-drift adjuvant from Clariant, based on a mixture of polyglycerol ester and rapeseed oil methyl ester
Sterling Blue® herbicide formulation of the diglycolamine (DGA) salt of dicamba (480 g/L acid equivalent; a.e.), from Winfield

### Preparation Examples

### A) Preparation of the Etherified Lactate Esters Used

### A1) Preparation of the Etherified Lactate Esters Based on Ethylene Oxide and Propylene Oxide Used

### 2-Ethylhexyl Lactate 2 PO/2 EO

A 2 L laboratory autoclave was initially charged at 100° C. under a nitrogen atmosphere with 160.0 g (0.792 mol) of 2-ethylhexyl lactate and 0.067 g of DMC catalyst. After 5 cycles of nitrogen/vacuum exchange between 0.1 and 3.0 bar (absolute), the mixture was heated up to 130° C. At this temperature, 91.88 g (1.584 mol) of propylene oxide (PO) were metered into the reactor while stirring within 10 minutes (min), in the course of which the pressure in the reactor rose from 0.21 bar (absolute) to 0.54 bar (absolute). After a further reaction time of 25 min, first the reactor pressure was adjusted with nitrogen to 2.15 bar (absolute) and then 69.68 g (1.584 mol) of ethylene oxide (EO) were metered into the reactor at 130° C. while stirring within 10 min, increasing the pressure from 2.15 bar (absolute) to 2.37 bar (absolute). After a further reaction time of 45 min, volatile components were baked out at 90° C. under reduced pressure for 30 min and the reaction mixture was then cooled down to room temperature. The product was finally admixed with 161 mg of IRGANOX® 1076.

### A2) Preparation of the Etherified Lactate Esters Based on Ethylene Oxide Used

### 2-Ethylhexyl Lactate 2 EO

A 2 L laboratory autoclave was initially charged at 100° C. under a nitrogen atmosphere with 160.0 g (0.792 mol) of 2-ethylhexyl lactate and 0.07 g of DMC catalyst. After 5 cycles of nitrogen/vacuum exchange between 0.1 and 3.0 bar (absolute), the mixture was heated up to 130° C. and then the reactor pressure was adjusted to 2.19 bar (absolute) with nitrogen. Subsequently, 69.68 g (1.584 mol) of EO were metered into the reactor while stirring at 130° C. within 30 min, increasing the pressure in the reactor from 2.19 bar (absolute) to 2.61 bar (absolute). After a further reaction time of 60 min, volatile components were baked out at 90° C. under reduced pressure for 30 min and then the reaction mixture was cooled down to room temperature. The product was finally admixed with 115 mg of IRGANOX® 1076.

### A3) Preparation of Further Etherified Lactate Esters

In an analogous manner to the abovementioned preparation methods A1) and A2), it is possible to prepare all the etherified lactate esters mentioned in table 1 below.

### B) Production of the Spray Liquors Used

### B1) Examples of Aqueous Spray Liquors

The composition of spray liquors A1-A7 is specified below. The spray liquors were produced by mixing the etherified lactate esters with water.

TABLE 1

| | | Amount of test |
|---|---|---|
| Spray | | substance |
| liquor | Test substance | [% by wt.] |
| A1 | Synergen ® OS | 0.25 |
| A2 | 2-ethylhexyl lactate 2 EO | 0.1 |
| A3 | 2-ethylhexyl lactate 2 EO/2 PO | 0.1 |
| A4 | lauryl lactate 2 PO/5 EO | 0.1 |
| A5 | cetyl lactate 5 EO | 0.1 |
| A6 | cetyl lactate 10 EO | 0.1 |
| A7 | cetyl lactate 2 PO/5 EO | 0.1 |

### B2) Examples of Spray Liquors Comprising Commercial Dicamba Formulation

The composition of spray liquors B1-B4 is specified hereinafter. These spray liquors are produced by mixing Sterling Blue® from Winfield (aqueous SL formulation of the diglycolamine (DGA) salt of dicamba 480 g/L a.e.), water and the test substance.

TABLE 2

| | | | Amount of |
|---|---|---|---|
| | Amount of | | test |
| Spray | Sterling Blue ® | | substance |
| liquor | [% by weight] | Test substance | [% by wt.] |
| B1 | 0.5 | — | — |
| B2 | 0.5 | Synergen ® OS | 0.25 |
| B3 | 0.5 | cetyl lactate 2 PO/5 EO | 0.1 |
| B4 | 0.5 | 2-ethylhexyl lactate 2 PO/ | 0.1 |
| | | 2 EO | |

### C) Use Examples

### C1) Measurement of Droplet Size Distribution

A Malvern Spraytec “real-time spray sizing system” was used to determine the droplet size distribution. For this purpose, the system (STP5321, Malvern Instruments GmbH, Heidelberg, Germany) was installed in a specially constructed spray cabin, with the option of being able to choose spray applications customary in practice with freely adjustable pressure for various hydraulic nozzles and freely adjustable distances (nozzle-target surface). The spray cabin can be darkened and all disruptive parameters can be switched off. For the measurements, the ID(3) 12002 injector nozzle (Lechler) having coarser droplet sizes was used. The pressure set was varied, and mean pressure was kept constant at 3 bar for the measurements reported hereinafter. The temperature and relative air humidity varied between 21.5° C. and 29° C. and between 33% and 56% respectively. In each test series, tap water was always measured as internal standard, and a spray liquor comprising the anti-drift adjuvant Synergen® OS (spray liquor Al in table 1 and spray liquor B2 in table 2) as commercially available standard.

The Spraytec measurement was made at the setting of 1 kHz, since measurements at 2.5 kHz or higher, and also other influencing parameters such as additional suction, were found to be negligible. The measurement in the spray mist was kept constant at a position with distances of exactly 29.3 cm from the nozzle and 0.4 cm from the perpendicular below the nozzle. The measurements were made within 5 seconds, and the mean of 6 repetitions is reported as the proportion by volume of the droplets having diameters <90 μm (“Vol 90”), <105 μm (“Vol 105”) and <150 μm (“Vol 150”) (percentage standard error 0.5%-2.5%). As a further measurement parameter, the proportion by volume of the droplets having diameter <210 μm (“Vol 210”) was determined and expressed in relation to the proportion by volume of droplets having diameter <105 μm (“Vol 210/Vol 105”). In addition, the percentage reduction in the proportion by volume of droplets having diameter <105 μm in the case of use of spray liquors containing etherified lactate esters was calculated in comparison to the use of tap water as internal standard (“Red 105”).

### C1 a) Use Example

Droplet size distribution of ID(3) 12002 injector nozzle (at 3 bar) using spray liquors A1-A7 (for composition see table 1).

TABLE 3

| | | Vol 90 | Vol 105 | Vol 150 | | |
|---|---|---|---|---|---|---|
| Spray | Test | [% by | [% by | [% by | Vol 210/ | Red 105 |
| liquid | substance | vol.] | vol.] | vol.] | Vol 105 | [%] |
| Water | Water | 1.88 | 2.95 | 6.54 | 3.88 | — |
| A1 | Synergen ® | 0.98 | 1.48 | 2.73 | 3.04 | 49 |
| (refer- | OS | | | | | |
| ence) | | | | | | |
| A2 | Ethylhexyl | 1.00 | 1.55 | 3.81 | 5.64 | 48 |
| (inven- | lactate | | | | | |
| tion) | 2 EO | | | | | |
| A3 | Ethylhexyl | 0.94 | 1.40 | 2.97 | 4.58 | 53 |
| (inven- | lactate | | | | | |
| tion) | 2 PO/2 EO | | | | | |
| A4 | Lauryl | 1.63 | 2.62 | 6.40 | 5.65 | 12 |
| (inven- | lactate | | | | | |
| tion) | 2 PO/5 EO | | | | | |
| A5 | Cetyl | 1.02 | 1.52 | 3.01 | 3.79 | 48 |
| (inven- | lactate | | | | | |
| tion) | 5 EO | | | | | |
| A6 | Cetyl | 1.30 | 2.08 | 4.98 | 4.82 | 30 |
| (inven- | lactate | | | | | |
| tion) | 10 EO | | | | | |
| A7 | Cetyl | 0.86 | 1.35 | 2.81 | 4.01 | 54 |
| (inven- | lactate | | | | | |
| tion) | 2 PO/5 EO | | | | | |

### C1 b) Use Example

Droplet size distribution of ID(3) 12002 injector nozzle (at 3 bar) using spray liquors B1-B4 comprising commercial dicamba (for composition see table 2).

TABLE 4

| | | | Vol | Vol | | |
|---|---|---|---|---|---|---|
| | | Vol 90 | 105 | 150 | | |
| Spray | Test | [% by | [% by | [% by | Vol 210/ | Red 105 |
| liquid | substance | vol.] | vol.] | vol.] | Vol 105 | [%] |
| Water | — | 1.79 | 2.83 | 6.39 | 3.97 | — |
| B1 | — | 3.44 | 4.79 | 9.02 | 3.22 | 69 |
| (refer- | | | | | | (increase) |
| ence) | | | | | | |
| B2 | Synergen ® | 0.82 | 1.24 | 2.21 | 5.42 | 56 |
| (inven- | OS | | | | | |
| tion) | | | | | | |
| B3 | Cetyl | 1.02 | 1.68 | 4.26 | 4.05 | 40 |
| (inven- | lactate | | | | | |
| tion) | 2 PO/5 EO | | | | | |
| B4 | 2-Ethylhexyl | 1.09 | 1.57 | 3.06 | 2.81 | 44 |
| (inven- | lactate | | | | | |
| tion) | 2 PO/2 EO | | | | | |

### D) Dynamic Surface Tension

Dynamic surface tension was determined via the bubble pressure method (BP2100 tensiometer, Krüss). Over a relevant timespan for the spray application of agrochemicals in aqueous dilution (called the surface age in the bubble pressure method) of 200 milliseconds (ms), the value of dynamic surface tension in [mN/m] correlates with adhesion on plants that are difficult to wet, such as barley (cereal). A value of 50 mN/m (at 20-21° C.), relative to water (72.8 mN/m), gives an improvement in adhesion from “zero adhesion” (0%) to about 50% (Baur P., Pontzen R.; 2007; Basic features of plant surface wettability and deposit formation and the impact of adjuvant; in R. E. Gaskin ed. Proceedings of the 8th International Symposium on Adjuvant for Agrochemicals; Publisher: International Society for Agrochemical Adjuvant (ISAA), Columbus, Ohio, USA).

It is additionally known from the literature that surface-active substances that lower dynamic surface tension normally show an adverse effect on spray drift and lead to spray mist with an increased content of fine droplets (Hilz et al., Spray drift review: The extent to which a formulation can contribute to spray drift reduction, Crop Protection 44 (2013) 75-83). Surprisingly, some alkoxylated lactate esters, in spite of low dynamic surface tension, show excellent drift-reducing properties (see table 5).

TABLE 5
Dynamic surface tension at 200 ms [mN/m]

| | Amount of | Amount of | Amount of |
|---|---|---|---|
| Test substance | 0.03% by wt. | 0.1% by wt. | 0.3% by wt. |
| Synergen ® OS | 73.2 | 70.8 | 65.8 |
| Cetyl lactate | 68.3 | 59.9 | 56.3 |
| 5 EO | | | |
| Cetyl lactate | 64.0 | 61.7 | 58.9 |
| 10 EO | | | |
| Cetyl lactate | 66.8 | 59.7 | 55.8 |
| 2 PO/5 EO | | | |
| Cetyl lactate | 62.7 | 59.7 | 57.0 |
| 2 PO/10 EO | | | |

1. A composition for reducing drift on application of a crop treatment composition, comprising one or more etherified lactate esters of the formula (I) 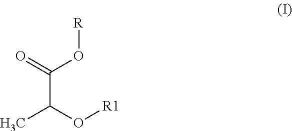
in which
R is unbranched or branched saturated alkyl having 1 to 30 carbon atoms or is unbranched or branched, mono- or polyunsaturated alkenyl having 2 to 30 carbon atoms,
R1 is a radical of the formula -(AO)ₘ-R′,
(AO)ₘ is formed from ethylene oxide units, is formed from propylene oxide units, is formed from butylene oxide units, is formed from mixtures of ethylene oxide and propylene oxide units or is formed from mixtures of ethylene oxide and butylene oxide units, where m on average is a number from 1 to 30, and
R′ is hydrogen, a branched or unbranched saturated alkyl radical having 1 to 20 carbon atoms or is a branched or unbranched, mono- or polyunsaturated alkenyl radical having 2 to 20 carbon atoms.

2. The composition for reducing drift on application of a crop treatment composition as claimed in claim 1, wherein
R is unbranched or branched saturated alkyl having 2 to 18 carbon atoms or is unbranched or branched, mono- or polyunsaturated alkenyl having 2 to 18 carbon atoms,
R1 is a radical of the formula -(AO)ₘ-R′,
(AO)ₘ is formed from ethylene oxide units, is formed from propylene oxide units, is formed from butylene oxide units, is formed from mixtures of ethylene oxide and propylene oxide units or is formed from mixtures of ethylene oxide and butylene oxide units, where m on average is a number from 1 to 20, and
R′ is hydrogen, a branched or unbranched saturated alkyl radical having 1 to 18 carbon atoms or is a branched or unbranched, mono- or polyunsaturated alkenyl radical having 2 to 18 carbon atoms.

3. The composition for reducing drift on application of a crop treatment composition as claimed in claim 1, wherein
R is butyl, hexyl, ethylhexyl, capryl, caprinyl, lauryl, myristyl, cetyl, stearyl or oleyl,
R1 is a radical of the formula -(AO)ₘ-R′,
(AO)ₘ is formed from ethylene oxide units, is formed from propylene oxide units, is formed from butylene oxide units or is formed from mixtures of ethylene oxide and propylene oxide units, where m on average is a number from 1 to 20, and
R′ is hydrogen, a branched or unbranched saturated alkyl radical having 1 to 10 carbon atoms or is a branched or unbranched, mono- or polyunsaturated alkenyl radical having 2 to 10 carbon atoms.

4. The composition for reducing drift on application of a crop treatment composition as claimed in claim 1, wherein
R is ethylhexyl,
R1 is -(AO)ₘ-R′,
(AO)ₘ is selected from the group consisting of the following radicals:
a) (PO)ₓ(EO)_{y} in which x on average is a number from 1 to 5 and y on average is a number from 1 to 10, and
b) (EO)_{y} in which y on average is a number from 1 to 10 and
R′ is hydrogen.

5. The composition for reducing drift on application of a crop treatment composition as claimed in claim 1, wherein
R is lauryl,
R1 is -(AO)ₘ-R′,
(AO)ₘ is selected from the group consisting of the following radicals:
a) (PO)ₓ(EO)_{y} in which x on average is a number from 1 to 5 and y on average is a number from 1 to 10, and
b) (EO)_{y} in which y on average is a number from 1 to 10 and
R′ is hydrogen.

6. The composition for reducing drift on application of a crop treatment composition as claimed in claim 1, wherein
R is cetyl,
R1 is -(AO)ₘ-R′,
(AO)ₘ is selected from the group consisting of the following radicals:
a) (PO)ₓ(EO)_{y} in which x on average is a number from 1 to 5 and y on average is a number from 1 to 10, and
b) (EO)_{y} in which y on average is a number from 1 to 10 and
R′ is hydrogen.

7. The composition for reducing drift on application of a crop treatment composition as claimed in claim 1, wherein
R is butyl,
R1 is -(AO)ₘ-R′,
(AO)ₘ is (PO)ₓ(EO)_{y} in which x on average is a number from 1 to 10 and y on average is a number from 1 to 10, and
R′ is hydrogen.

8. The composition for reducing drift on application of a crop treatment composition as claimed in claim 1, wherein the one or more lactate esters of the formula (I) are present in a crop treatment composition in the form of a spray liquor and the amount of the one or more etherified lactate esters of the formula (I) in the spray liquor is from 0.001% to 5% by weight, based in each case on the total weight of the spray liquor.

9. A method of reducing drift on application of a crop treatment composition, wherein a spray liquor comprising from 0.001% to 5% by weight, based in each case on the total weight of the spray liquor, of one or more lactate esters of the formula (I) 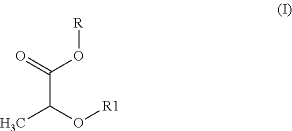
in which
R is unbranched or branched saturated alkyl having 1 to 30 carbon atoms or is unbranched or branched, mono- or polyunsaturated alkenyl having 2 to 30 carbon atoms,
R1 is a radical of the formula -(AO)ₘ-R′,
(AO)ₘ is formed from ethylene oxide units, is formed from propylene oxide units, is formed from butylene oxide units, is formed from mixtures of ethylene oxide and propylene oxide units or is formed from mixtures of ethylene oxide and butylene oxide units, where m on average is a number from 1 to 30, and
R′ is hydrogen, a branched or unbranched saturated alkyl radical having 1 to 20 carbon atoms or is a branched or unbranched, mono- or polyunsaturated alkenyl radical having 2 to 20 carbon atoms, is sprayed onto the plants to be treated or the locus thereof.

10. (canceled)
